(19) United States
(12) Patent Application Publication
(10) Pub. No.: US 2014/0061330 A1
(43) Pub. Date: Mar. 6, 2014

(54) ATOMIZER FOR AGRICULTURAL AIRCRAFT

(71) Applicant: Cesar Gustavo URIARTE, Buenos Aires (AR)

(72) Inventor: Cesar Gustavo URIARTE, Buenos Aires (AR)

(21) Appl. No.: 13/804,618

(22) Filed: Mar. 14, 2013

(30) Foreign Application Priority Data
Mar. 30, 2012 (AR) 20120101125

(51) Int. Cl. B05B 3/10

(52) U.S. Cl. CPC B05B 3/1014
USPC 239/224

(57) ABSTRACT

The present disclosure relates to an atomizer for an agricultural aircraft containing a rotary atomizer with a propeller having a diffuser cone which has in its interior and exterior parts ribbed guides. These ribbed guides help to obtain the perfect dispersion and the uniformity of the micrometric drops, thus improves the flow and the amplitude of the spray by each passing of the aircraft.

The present disclosure relates to an atomizer for an agricultural aircraft, containing a rotary atomizer with a propeller having a diffuser cone which has in its interior and exterior parts ribbed guides. These ribbed guides help to obtain the perfect dispersion and the uniformity of the micrometric drops, thus improves the flow and the amplitude of the spray by each passing of the aircraft. It also includes a Gradual Control Unit, GCU, which is installed directly on the output of the liquid of the diffuser cone. The propeller is made up of 3 or more butterfly paddles, covering more than 90% of the surface circumference that forms the propeller when turning, increasing it by at least 200%. The surface of the big face of the diffuser cone allows the diameter of the diffuser cone to be extended and to increase the coverage of the aircraft on each pass. The gradual control unit is placed inside a counter cone that has the end named bell mili-metrically separated from the inner surface of the diffuser cone. The liquid due to the centrifugal force and guided by internal and external ribbed guides of the diffuser cone is fired by the cone forming a uniform and homogeneous cloud of spray droplets. Therefore, the liquid travels after leaving the GCU, and is directed inside the counter cone to the part called the bell and then directly passes to the diffuser cone that is to be fired by the centrifuge force. The atomizer for agricultural aircraft has a hydraulic brake which works against the atomizer on a brake plate of stainless steel; this system is part of the fixing bracket of every atomizer.

The spray for aircraft agricultural has a brake hydraulic that works against spray on a disc of stainless steel; the east system is part of the support of snap of every atomizer.

### BACKGROUND OF THE INVENTION

The atomizer for agricultural aircraft according to the present disclosure is considerably more efficient, with greater operational safety and spray and pulverized qualities than currently known atomizers in the market, with more benefits, better yields, and reduced application costs. The more modern atomizers for agricultural aircraft founded in the market, include a rotating basket that rotates at high revolutions per minute in view of the effect exerted by the air on the blades of the propeller located in the body of the atomizer, the centrifuge force that occurs in the atomizer passes the liquid through the wire mesh of the basket, where the droplets are formed, and thus getting a spray in the form of fine drops. The problem is that the drops that formed are not all of the same size, therefore there is no uniformity, this brings about that during a chemical application, there is not an adequate and reliable application, nor a good penetration of the product in the crop, producing loss because of the wind and of the differences in the size of the drops.

The prior art tried to fix the problem by changing the rotation speed, by controlling the variation of the angle of the blade of the propeller; this control achieves to change the desired droplet size, but does not fix the most important aspect, which is the uniformity of the droplets, since having a uniformity in the drops produces an excellent spray. Another important element is the output pressure of the liquid, that does not affect the size of the drops; but the pressure is important for the uniformity of the same.

All known atomizers in the market have a gradual control unit, in the exit that goes from the main bar liquid distributor to each peak. Then from the main bar liquid distributor, exists to each atomizer a feeding opening, where is installed the GCU (flow control), then located the anti-drip valve that attaches to the atomizer. The travel of the liquid from the flow control to the basket of the atomizer is approximately 40 cm, which produces the pressure to reach the flow control valve and exits through a hole of 2 mm or up to the larger ⅚ mm, with a loss of pressure of 90% or more. If the 2 mm hole is used, and the liquid travels through a duct having a diameter of 6/7 mm from the control valve to the basket of distribution, then the pressure decreases or is lost, reaching the liquid with low pressure the exit of the basket, that works by splash and centrifuge, which requires high revolutions to produce an acceptable drip.

In the year 1987, the Argentinean Air Force, according to the CAM 049 of the DNA (Airworthiness), authorized to use in a fumigation aircraft one of the many atomizers of the present inventor, that also had a diffuser cone located on the exit of the basket; but that differs from the atomizer for agricultural aircraft of the present disclosure, rotary with a propeller attached to the atomizer, by several factors, as for example, the counter cone, the gradual control unit, hydraulic brake, dispenser, lid in main body, the internal and external ribbed guides of the diffuser cone, among other differences.

AR patent 228495 describes a sprayer device to distribute fluids at low volume; as well as the main commercially-known atomizers, differ mainly from the present disclosure in the following elements that are listed below and are the ones that make a great difference in the application of chemical products, having a very good penetration of the product in the crop, and also producing lower loss of the same. The atomizer, for agricultural aircraft, of the present disclosure comprises a rotary atomizer with a propeller coupled to the atomizer, a diffuser cone which has in its interior and exterior parts grooved guides that perfect the dispersion and the uniformity of the droplets, a gradual control unit GCU placed inside a counter cone, having the liquid at the exit a total working pressure and where opens instantly to the exit of the diffuser cone, producing a better uniformity of the droplets and a greater encompassing spectrum of spray to very low RPM almost to 50% of that required by the atomizer of the basket.

### SUMMARY OF THE INVENTION

The main elements are:

A diffuser cone grooved in the interior and exterior faces.

A graduate control unit system (GCU).

A propeller that partially covers at least 90% of the surface that turns with its blades.

A hydraulic brake that is part of the fixing bracket of the atomizer.

With the following result:

The Cone, for being grooved, produces a more spray surface; it is said does not include the basket to produce the drops.

The GCU (gradual control unit) is placed inside of the counter cone with a direct exit to the grooved diffuser cone. Does not lose pressure, which produces a uniformity.

The blades of the propeller are trapezoidal, covering more than 90% of the describing circumference, increasing the surface of the diffuser cone exit by almost 200%; this is produced by the Venturi effect for receiving the pressure of the wind.

Turning of the atomizer, in both ways, improving the performance, and avoiding with the best coverage with its extremes, the VORTEX effect.

More coverage by pass of the aircraft.

Best uniformity of the drops by square inch.

Decrease of the rpm in more than 50% minor wear.

Use of the pressure and the low RPM for more flow and uniformity of the drops.

Individual hydraulic brake, built-in to the atomizer; having the brake incorporated, avoids the wear by functioning in a vacuum, or in the flight to resupply, or the travel to and from the operation base.

DESCRIPTION OF THE DRAWINGS

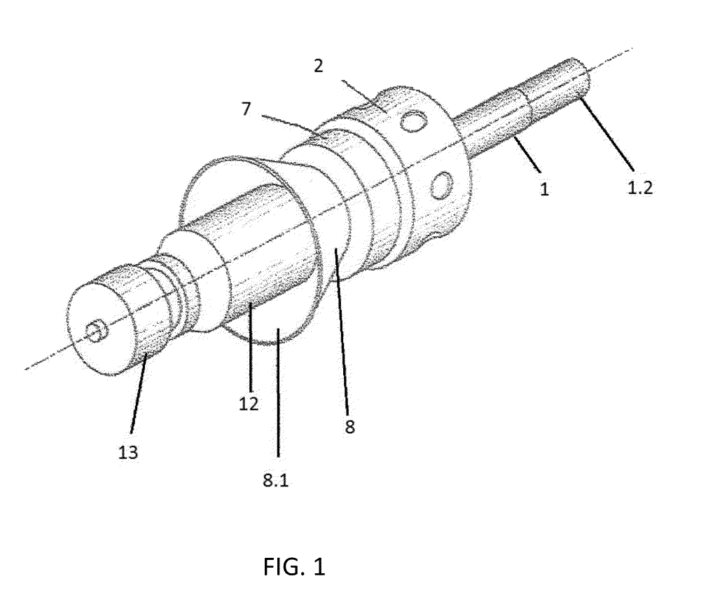

FIG. 1 shows a perspective front view of the atomizer according to an embodiment of the present invention;

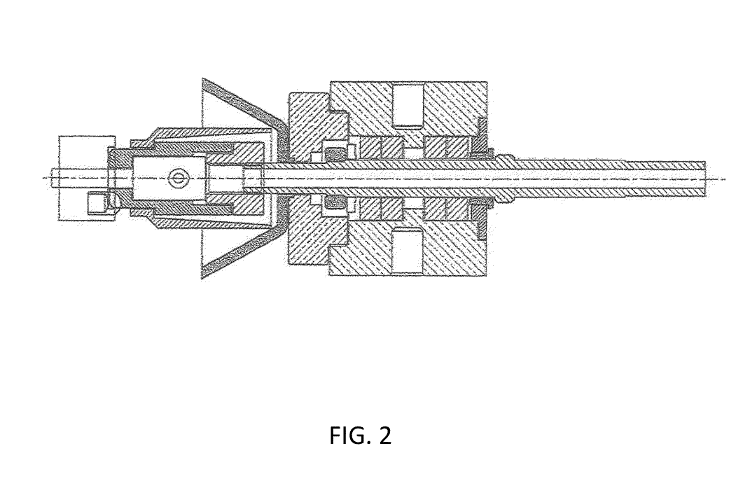

FIG. 2 shows a cross sectional view of the atomizer of FIG. 1;

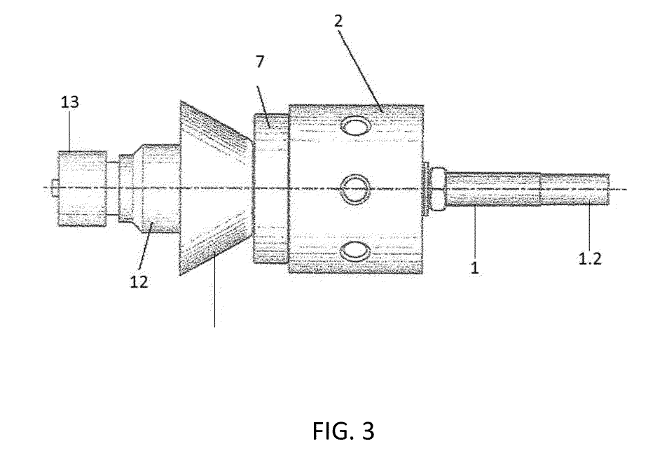

FIG. 3 shows a front view of the atomizer of FIG. 1;

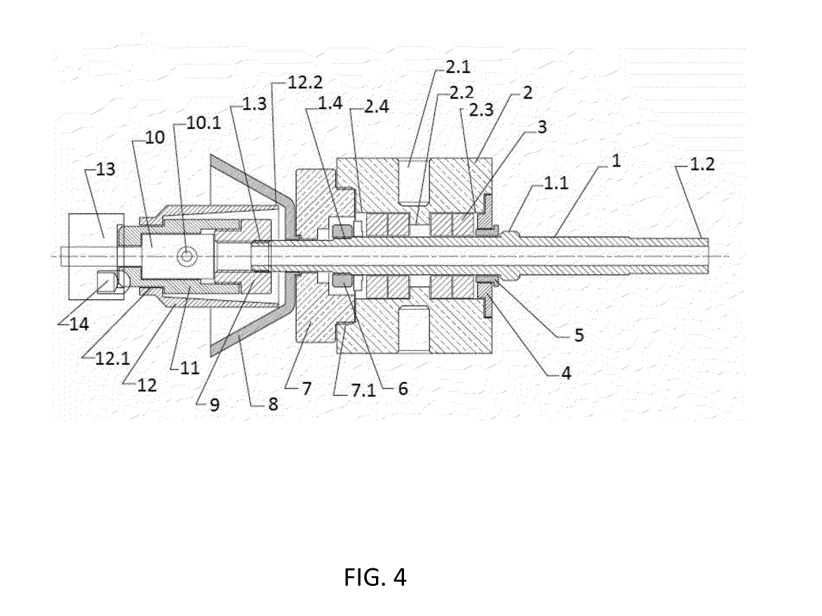

FIG. 4 shows a front view of the atomizer of FIG. 3 including the elements numbers;

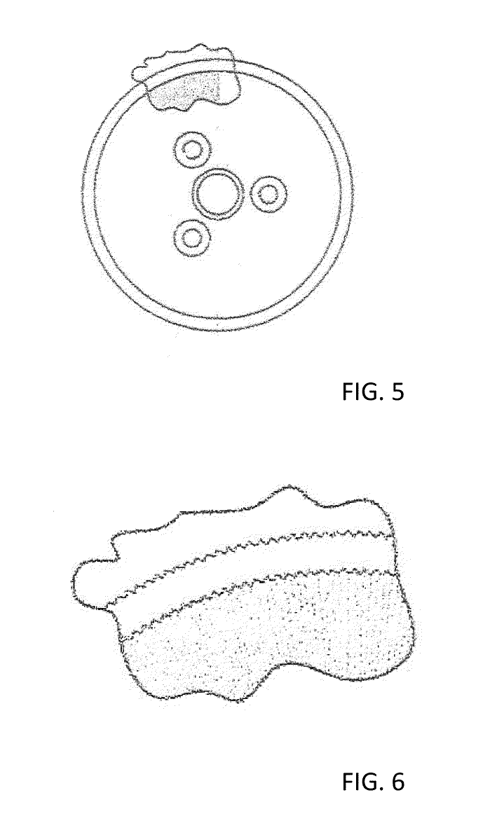

FIG. 5 shows a top view of the cone according to the present invention;

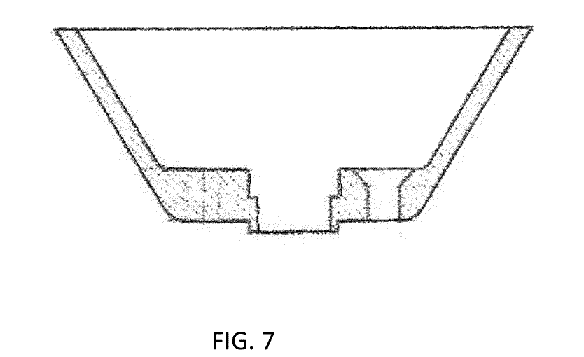

FIG. 6 shows a detailed view of the Internal ribbed guides according to an exemplary embodiment of the present invention; and

FIG. 7 shows cross sectional view of the cone of FIG. 5;

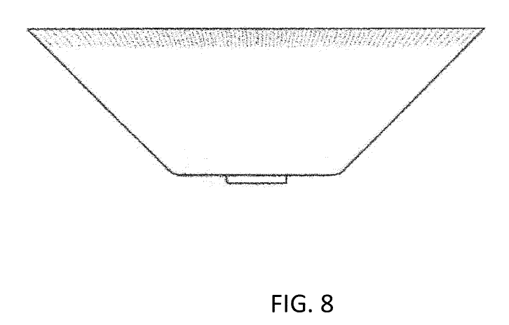

FIG. 8 shows a detailed view of the cone including the external ribbed guides; and

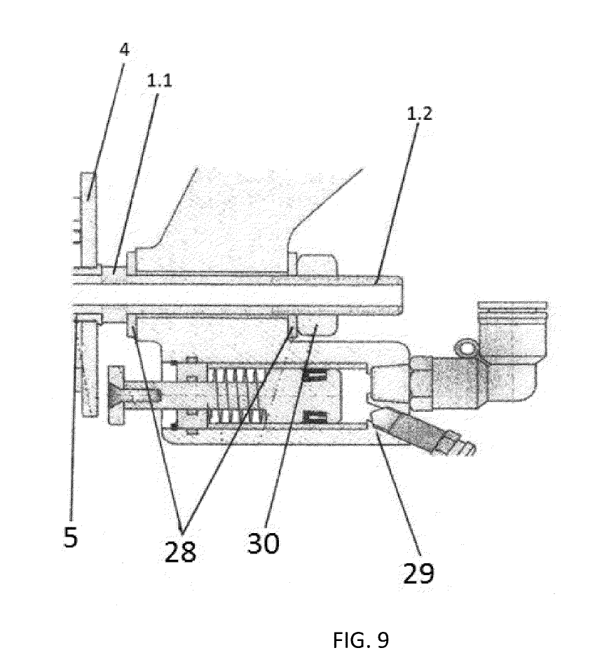

FIG. 9 shows a top view of the brake according to the present invention.

### DESCRIPTION OF THE INVENTION

The present disclosure relates to an atomizer for agricultural aircraft, comprising a rotary atomizer with the propeller coupled to the atomizer. In particular, the atomizer has a diffuser cone which has on its surface ribbed guides, that help to obtain a perfect dispersion and the uniformity of micrometric drops, which are formed, due among other things, to the centrifugal force. The atomizer includes a hollow shaft, where all the other parts are fixed, being all of them of revolution, and that are set on the axis named main shaft by means of threads. In the middle part of the shaft there is a bump. The initial end is threaded where is placed the element named main body that on its outer face and on a same diameter takes a minimum of 3 holes and a maximum of 9, all threaded for the fixing of blades, to form a propeller attached to the main body. The main body has within it an inner bump and also has two recesses. Below and on the end are washers and nuts that fix and close the set of pieces located on the main shaft. After that, it placed the element named main body cover and then comes the element named diffuser cone that is hollow and acts as a screen. Then is located the element named threaded bushing, and then the element called gradual control unit (GCU) which regulates the passage of the liquid, then the element named body of GCU, which has a hole for the regulation pass of the liquid flow. Above these parts, it goes the element named counter cone, which has in the end the area called bell, which is exactly separated by millimeters of the smaller internal face of the diffuser cone, thus the flow of the liquid powdered exit to the outside. Finally is an element name top locking bumper to hold them in and prevent movement.

The atomizer has built-in, at the other end of the main shaft of the equipment, a disc of stainless steel, which is part of the individual single hydraulic brake, incorporated into the atomizer. Having the brake built-in, avoids the wear by operating in a vacuum, or in the flight to resupply itself, and/or in the transfer to and from the operation base.

The present disclosure is an atomizer for agricultural aircraft that includes a rotary atomizer with a propeller coupled to the atomizer. This sprayer is used for spraying plantations, the use of the present disclosure, achieves very fine degree particles and a scope or range greater than expected. This atomizer goes to the end of the travel pipe of the system need to send the sprayer liquid, i.e. is a diffuser that achieved to spray particle very fine particulates or macro particles that better penetrate on the crops and optimize the emission of the amount of particles by a regulation that remains fixed during the use. For easy understanding, we are going to describe the references of the Figures; mainly referring to FIG. 4, that is where the atomizer is shown with all their references.

The atomizer of the present disclosure includes a hollow main shaft 1; the hollow main shaft 1 is the element axis on which all of the other elements are connected, being all of the other parts of revolution, since they are positioned on the hollow main shaft 1 by means of threads between them. The middle section of the hollow main shaft 1 and its exterior face there is a cap 1.1 that has a form of a hexagonal nut. The hollow main shaft 1 has an initial end 1.2. The final end 1.3 of the shaft 1 is threaded, and between the end 1.2 and the final end 1.3 is a threaded recess 1.4. After the end 1.1 is located a main body 2 that over its exterior face has various threaded holes 2.1 for fixing of the blades that form the propeller. The main body 2 is hollow inside with an internal stop 2.2 that functions as internal divisor stopper and also has two concavities: the initial concavity 2.3 and the final concavity 2.4. Between the main body 2 and the shaft 1 are located several bearing parts called bushings separators 3.

After the bushings separators 3 and over an extreme there is incorporated a disc of stainless steel, the brake plate 4, and over this goes the bumper bushing 5 of the brake plate 4. A nut 6 fixes and closes the set of parts located up to now about the shaft 1.

Then, a main body cover 7 having a threaded portion 7.1 is placed a thread about the main body 2. Then a diffuser cone 8 that is recessed and acts as a screen is placed. A threaded bushing 9 is threaded piece to the final end 1.3, and then a dispenser 10 that is the element about which is the regulation of the passage of the liquid through the hole 10.1. Then, the gradual control unit “GCU” 11 is placed, the GCU 11 has a hole 11.1 that will be made to coincide more or less with the hole 10.1 achieving the adjustment on the flow of liquid. Above these parts, goes the counter cone 12, in which the hub 12.1 contacts with the GCU 11, the farthest end of the counter cone is the bell 12.2, this should not touch the diffuser cone 8, but it should be a separation of millimeters, thus the liquid flow sprays out towards the outside. Then and finally goes a top cap 13 which has a fixing bolt screw 14, for not getting out or moving any component.

### REFERENCES TO THE FIGURES

The references have the same number and are the same in all the figures:
1 Main Shaft;
1.1 Cap
1.2 Initial end of the shaft
1.3 Final end of the shaft
1.4 Threaded recess
2 Main body.
2.1 Threaded hole
2.2 Internal stop
2.3 Initial concavity
2.4 Final concavity
2.5 Armored turning globe
3 Bushings separators
4 Brake plate
5 Bumper bushing
6 Nut
7 Main body cover
7.1 Threaded portion
8 Diffuser cone
8.1 Internal ribbed guide
8.2 External ribbed guide
9. Threaded bushing
10 Dispenser
10.1 Hole
11. Gradual control unit GCU
11.1 Hole of the GCU
12 Exhausts
12.1 Bushing
12.2 Bell
13 Top stop
14 PIN fastening threaded
28 Half Washers
29 Support
30 Nut thread support.

That it has been the invention and the way in which it has to be practiced, I declare in what rightly refers as my exclusive property, described as follows:

What is claimed is:

1. An atomizer for an agricultural aircraft comprising:
a rotary atomizer including a hollow main shaft, the hollow main shaft including a first end and a second end;
a main body located on the first end of the hollow main shaft;
a propeller attached to recess on the main body;
a main cover mounted to the hollow main shaft and having a first end connected to the main body;
a diffuser cone mounted on the main shaft, the diffuser cone connected to a second end of the main cover, the diffuser cone having an internal face, an external face, and ribbed guides located on the internal and external faces;
a dispenser located on the main hollow shaft near the diffuser cone;
a gradual control unit located on the hollow main shaft near the dispenser, the gradual control unit including holes that coincide with holes on the dispenser;
a counter cone located on the main hollow shaft and facing the diffuser cone, the counter cone including a bell, the bell is located very close to the diffuser cone but without touching the diffuser cone.

2. The atomizer according to claim 1, further including a hydraulic brake connected to the main shaft.

3. The atomizer according to claim 2, wherein the hydraulic brake is built in into the atomizer.

4. The atomizer according to claim 1, wherein hollow main body includes an internal stop forming two concavities.

5. The atomizer according to claim 1, wherein counter cone includes a hub, the contacts with the gradual control unit.
